(19) United States
(12) Patent Application Publication
(10) Pub. No.: US 2016/0096389 A1
(43) Pub. Date: Apr. 7, 2016

(54) FLEXOGRAPHIC PRINTING PLATE MATERIAL

(71) Applicant: KINYOSHA CO., LTD., Tokyo (JP)

(72) Inventors: Shigeru Nakano, Tokyo (JP); Ryuta Tanaka, Tokyo (JP); Yu Ariyoshi, Tokyo (JP)

(73) Assignee: KINYOSHA CO., LTD., Tokyo (JP)

(21) Appl. No.: 14/965,772

(22) Filed: Dec. 10, 2015

Related U.S. Application Data
(63) Continuation of application No. PCT/JP2013/066253, filed on Jun. 12, 2013.

(51) Int. Cl. B41N 1/00

(52) U.S. Cl. CPC B41N 1/006

(57) ABSTRACT

According to one embodiment, a flexographic printing plate material includes a printing layer for engraving containing rubber, a compressive layer, a base fabric layer provided between the printing layer for engraving and the compressive layer, and a reinforcement layer.

### CROSS-REFERENCE TO RELATED APPLICATIONS

This application is a Continuation Application of PCT Application No. PCT/JP2013/066253, filed Jun. 12, 2013, the entire contents of which are incorporated herein by reference.

### TECHNICAL FIELD

The present invention relates to a plate material used in flexography, capable of printing on various objects to be printed such as paper, cloth, polywood, and film bags. The plate material for flexography according to the present invention is used in a printing device, and is particularly suitable for a method for directly laser-engraving the outermost surface of a printing layer.

### BACKGROUND ART

Rubber plates or resin plates are used as a plate material for flexography, and plates formed of a photosensitive resin layer and a base layer are mainly used. When the photosensitive resin layer is used, a photolithographic method or a method in which an abrasion mask layer is engraved, to which light is exposed, and washing with a solvent is performed is used. Recently, methods in which a material is directly engraved with a laser have been developed. The laser-engraving does not require an exposure process and is completed by washing with water alone, and thus it receives attention due to its small environmental burden.

Patent Literature 1 relates to a plate for flexography or an original plate for a flexographic plate containing a photo-crosslinking resin layer on which a relief image is formed.

In addition, Patent Literature 2 relates to a multilayered sheet suitable for a printing blanket or a printing plate for flexography and letterpress printing. The multilayered sheet is formed from a vulcanizates, and contains a printing layer provided by the laser-engraving, at least one compressible layer, and at least one reinforcement layer. According to Patent Literature 2, the printing layer is directly brought into contact with the compressible layer, and thus a phenomenon occurs in which the compressible layer is deeply depressed in some areas which are located directly under areas of the printing layer to which a pressure is applied. It takes time until the depressions are restored, and thus the pressure is not equally applied to the printing layer, and a printing pressure cannot be made constant. For that reason, a phenomenon in which an ink is not uniformly transferred to an object to be printed may occur due to vibrations of printing device elements or a pattern arrangement on the plate material.

On the other hand, Patent Literature 3 describes that a flexographic printing plate, in which reliefs have very crisp edges and occurrence of melted edges is substantially completely inhibited, can be obtained by containing, as a substance absorbing laser irradiation, a conductive carbon black having a specific surface area of at least 150 m²/g, and a DBP number of at least 150 ml/100 g in a cross-linked elastomeric layer (A) on which the relief is formed.

Patent Literature 3, however, has a structure in which an elastic underlayer is disposed between the layer (A) and a substrate, and thus a counterforce becomes too high. Consequently, a bound phenomenon, as it's called, easily occurs in which uniform transfer cannot be performed on the object to be printed, and an ink may not be uniformly transferred to the object to be printed due to vibrations of printing device elements or a pattern arrangement on the plate material.

### CITATION LIST

### Patent Literatures

Patent Literature 1: Domestic Re-Publication of PCT International Application No. WO 00/39640
Patent Literature 2: Jpn. PCT National Publication No. 2012-524676
Patent Literature 3: Jpn. PCT National Publication No. 2006-523552

### BRIEF SUMMARY OF THE INVENTION

### Technical Problem

Provided is a flexographic printing plate material capable of stably and uniformly transferring an ink to an object to be printed, because of the excellent restoring property and the decreased bound phenomenon.

### Solution to Problem

According to the present invention, a flexographic printing plate material includes a printing layer for engraving containing rubber, a compressive layer, a base fabric layer provided between the printing layer for engraving and the compressive layer, and a reinforcement layer.

### Advantageous Effects of Invention

According to the present invention, a flexographic printing plate material having an excellent restoring property and a decreased bound phenomenon, and being capable of stably and uniformly transferring an ink to an object to be printed can be provided.

### BRIEF DESCRIPTION OF DRAWINGS

FIG. 1 is a cross-sectional view showing one embodiment of a flexographic printing plate material.

FIG. 2 is a cross-sectional view showing another embodiment of a flexographic printing plate material.

The accompanying drawings, which are incorporated in and constitute a part of the specification, illustrate embodiments of the invention, and together with the general description given above and the detailed description of the embodiments given below, serve to explain the principles of the invention.

### DETAILED DESCRIPTION OF THE INVENTION

A flexographic printing plate material according to an embodiment contains a printing layer for engraving containing a rubber, a compressive layer, a base fabric layer disposed between the printing layer for engraving and the compressive layer, and a reinforcement: layer. According to the flexographic printing plate material of the embodiment, since a wide area of the base fabric layer, located under an area of the printing layer for engraving to which a pressure is applied, receives the pressure, the wide area of the compressive layer is depressed, and the depression is quickly restored, and thus slight fatigue occurs and the durability is improved. Even if an ununiform pressure is applied to the plate material, the compressive layer, which is provided in the plate material, can absorb the pressure; as a result, it is possible to inhibit the occurrence of the bound phenomenon, and the ink can be stably and uniformly transferred to the object to be printed. In addition, because the base fabric layer can complement a role as the reinforcement layer, the effect of suppressing the elongation of the whole plate material can be increased, and the variation in the thickness of the plate material can be decreased. Furthermore, the base fabric layer can contribute to size stability of the whole plate material.

Each member forming the flexographic printing plate material is explained below.

### (1) Printing Layer for Engraving

The printing layer for engraving contains rubber, on which a relief can be formed by laser-engraving. It is possible to contain a resin in the printing layer for engraving in addition to the rubber, but the rubber is desirable as the main component because of its decreased production cost. Preferable examples of the rubber may include ethylene-propylene-diene rubber (EPDM). When EPDM is used, the printing layer for engraving having a long operating life, and excellent lightfast property and weatherability can be obtained, and it can be applied to an aqueous ink, which is frequently used in flexography.

It is desirable that the printing layer for engraving contains an inorganic porous substance having a specific surface area of greater than or equal to 40 m² and less than or equal to 1000 m² per 1 g of the rubber. The specific surface area of the inorganic porous substance is measured by the BET method. When the specific surface area is adjusted to 40 m² or more per 1 g of the rubber, the inorganic porous substance adsorbs melted edges, generated by the laser-engraving, and thus it is possible to prevent an appearance of the melted edges on the surface of the printing layer after the laser-engraving. When the specific surface area is adjusted to 1000 m² or less per 1 g of the rubber, it is easy to uniformly mix the inorganic porous substance with other starting materials, and thus the variation in the quality of the printing layer for engraving can be reduced. The preferable range is greater than or equal to 90 m² and less than or equal to 700 m², and the most desirable range is greater than or equal to 120 m² and less than or equal to 520 m².

Examples of the inorganic porous substance may include carbon black, and the like.

It is desirable that the printing layer for engraving has a thickness of 0.5 mm or more, whereby a sufficient relief depth can be secured upon the laser-engraving.

The printing layer for engraving has desirably a hardness within a range of greater than or equal to 40 and less than or equal to 85, in accordance with JIS-A. When the JIS-A hardness is adjusted to 40 or more, a surface abrasion resistance can be improved, deformation can be reduced, and misregistration can be decreased upon multicolor printing. When the JIS-A hardness is adjusted to 85 or less, the ink transfer property can be improved.

The hardness of the printing layer for engraving is measured under test piece preparation and standard conditions provided in JIS K 6250, in accordance with JIS K 6253 using a type A durometer.

### (2) Base Fabric Layer

The base fabric layer is disposed on a back surface of the printing layer for engraving. Examples of the base fabric layer may include a woven fabric, a non-woven fabric, and the like. It is desirable to use the woven fabric as the base fabric layer, to serve the role of suppressing the elongation.

### (3) Compressive Layer

The compressive layer contains desirably a porous rubber matrix, more preferably contains it as the main component. The rubber matrix is obtained, for example, by vulcanizing a composition containing unvulcanized rubber. The porous structure may be either an open-cell or closed cell.

The compressive layer has preferably a porosity within a range of greater than or equal to 10% and less than or equal to 70%. When the porosity is within the range described above, the compressive layer in which the fatigue occurs a little and which has good functions can be realized.

The porosity of the compressive layer is measured using a specific gravity measuring machine (for example, an electronic gravity meter EW-300SG manufactured by Alfa Mirage Co., Ltd). A base rubber, which is of the same kind as the compressive layer, is vulcanized in the same conditions as in the compressive layer, and a specific gravity thereof is measured (referred to as a “specific gravity A”). For example, in a case of Examples, the rubber is passed through an extruder while applying vent, the unvulcanized rubber, which has been molded into a sheet, is vulcanized at 145° C. for 15 minutes and a specific gravity A is measured. The same kind of base rubber as above, into which voids are introduced in the same manner as in the formation of the compressive layer, is vulcanized in the same conditions as in the measurement of the specific gravity A, and its specific gravity is measured (referred to as a “specific gravity B”). A porosity X is calculated by the following formula from the obtained specific gravities.

Porosity X (%)=(A−B)/A×100(%)

### (4) Reinforcement Layer

The plate material for flexography is used in a state in which it is installed into a printing device cylinder or a sleeve for installation to a printing device. The reinforcement layer performs a function as an elongation-suppressing layer, to suppress the elongation of the flexographic printing plate material, caused by tension applied upon the installation or removal.

The reinforcement layer is not elastic, and can be selected from a woven cloth, a film, a plastic sheet, a metal sheet, and the like.

In addition to the members (1) to (4) described above, members (5) and (6) described below may be contained.

### (5) Pressure-Sensitive Adhesive Layer

The pressure-sensitive adhesive layer is disposed, for example, on a back surface of the flexographic printing plate material. The pressure-sensitive adhesive layer can fix the flexographic printing plate material to a printing device cylinder or a sleeve for installation to a printing device through the pressure-sensitive adhesion. Examples of the printing device cylinder and sleeve include nylon and metals. The pressure-sensitive adhesive layer is formed, for example, from a resin or an elastomer. A re-peelable type is preferable. A material for the pressure-sensitive adhesive layer may include, for example, acrylic materials, silicone materials, urethane materials, and the like. When the pressure-sensitive adhesive layer is used, the flexographic printing plate material can be easily installed to the printing device cylinder or the sleeve for installation to a printing device, because it is unnecessary to use a double-sided tape or a cushion tape.

Note that the present application encompasses an embodiment in which the flexographic printing plate material is installed to the printing device with the double-sided tape or the cushion tape instead of the pressure-sensitive adhesive layer.

### (6) Adhesive Layer

For joining the members (1) to (5) described above, an adhesive layer can be used. The adhesive layer can be formed, for example, from a rubber matrix. The rubber matrix is obtained, for example, by vulcanizing a composition containing unvulcanized rubber.

The thickness of the flexographic printing plate material, and the thickness of each member forming the flexographic printing plate material are not particularly limited, and they may be appropriately varied depending on the use of the flexographic printing plate material, and the like. When the thickness of the flexographic printing plate material (hereinafter referred to as a “plate material thickness”) is adjusted to a range of greater than or equal to 1.5 mm and less than or equal to 2.75 mm, it is desirable that a ratio of the thickness of the compressive layer to the plate material thickness is adjusted to 10% or less (preferably greater than or equal to 1% and less than or equal to 10%), and a ratio of the thickness of the printing layer for engraving to the plate material thickness is greater than or equal to 22% and less than or equal to 65%. In order to decrease the fatigue of the plate material to be printed in a case of a thin plate material having a thickness of greater than or equal to 1.5 mm and less than or equal to 2.75 mm, it is desirable to increase the thickness of the compressive layer. On the other hand, when the compressive layer is thickened, it is necessary to decrease the thickness of the printing layer for engraving, thus the desired relief depth cannot be obtained (engraving cannot be performed up to the desired depth) when the printing layer for engraving is subjected to the laser-engraving, and excessive ink is accumulated beyond the relief capacity (the depth engraved) upon the printing, which causes stains on areas where a line is not drawn. The present inventors have found that in a case where the plate material thickness is greater than or equal to 1.5 mm and less than or equal to 2.75 mm, if the ratio of the thickness of the printing layer for engraving to the plate material thickness is greater than or equal to 22% and less than or equal to 65%, the flexographic printing plate material having small fatigue can be realized while the desired relief depth is secured when the ratio of the compressive layer to the plate material thickness is 10% or less.

The thickness of the flexographic printing plate material, and the thickness of each of the members forming the flexographic printing plate material are measured in accordance with a measurement test method provided in JIS 9611. Measurement is performed on six points per plate material or member, and a median value among the values measured of the six points is defined as a thickness of the plate material or each member.

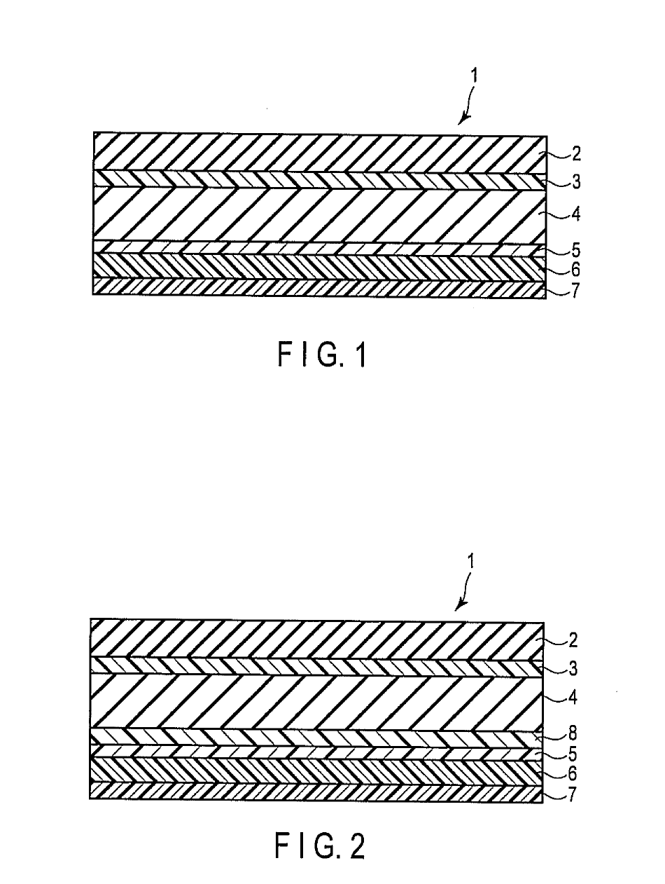

One embodiment of the flexographic printing plate material is explained referring to drawings. A flexographic printing plate material 1, shown in FIG. 1, is an integrated product in which a printing layer for engraving 2, a first base fabric layer 3, a compressive layer 4, an adhesive layer 5, a reinforcement layer (an elongation-suppressing layer) 6, and a pressure-sensitive adhesive layer 7 are laminated in this order. It is also possible to dispose a second base fabric layer 8 between the compressive layer 4 and the adhesive layer 5 in the plate material for flexography 1, as shown in FIG. 2. When the second base fabric layer 8 is used, the elongation-suppressing effect and the dimensional stability can be further improved. The base fabric layer is not limited a monolayer or a two-layer structure, and the base fabric layer having three or more layers may by used.

Examples are explained below.

### Example 1

With 100 parts by weight of EPDM were mixed 5 parts by weight of a zinc oxide powder, 1.5 parts by weight of a sulfur powder, 1.5 parts by weight of a vulcanization accelerator (0.8 parts by weight of MBTS (dibenzothiazolyl disulfide) and 0.7 parts by weight of TMTD (tetramethylthiuram disulfide)), 1 part by weight of stearic acid, 10 parts by weight of an inorganic porous substance (EC600JD™ Ketjenblack having a BET specific surface area of 1270 m²/g) and 7 parts by weight of a softener (paraffin process oil), and the mixture was molded to obtain a printing layer to be engraved. The inorganic porous substance had a BET specific surface area of 127 m² per 1 g of EPDM.

With 100 parts by weight of EPDM were mixed 5 parts by weight of a zinc oxide powder, 1.5 parts by weight of a sulfur powder, 2.2 parts by weight of a vulcanization accelerator (1.5 parts by weight of CBS (N-cyclohexylbenzothiazole-2-sulfenamide) and 0.7 parts by weight of TMTD), 1 part by weight of stearic acid, 40 parts by weight of SRF carbon black and 10 parts by weight of a softener (paraffin process oil). With the resulting mixture was further mixed 5 parts by weight of Matsumoto Microsphere F-65, manufactured by Matsumoto Yusi-Seiyaku Co., Ltd., and then the mixture was molded through an extruder into a sheet, while applying vent. The obtained sheet was put on one side of a base fabric layer (a woven fabric having a thickness of 0.2 mm), which was vulcanized at a temperature of 145° C. for 15 minutes to obtain a vulcanized compressive layer.

As a reinforcement layer (an elongation-suppressing layer), a polyester film having a thickness of 0.1 mm was prepared.

The printing layer to be engraved, the compressive layer, the base fabric layer, and the reinforcement layer were integrated in the following method to obtain a flexographic printing plate material.

The adhesive layer was coated on the surface of the compressive layer in the composite of the pre-vulcanized compressive layer and the base fabric layer, on which the reinforcement layer was laminated to obtain a composite of the base fabric layer, the compressive layer, and the reinforcement layer. The printing layer to be engraved, which had been formed into a sheet, was put on the top surface of the base fabric layer, and the obtained integrated product was vulcanized in a vulcanizer at a temperature of 140° C. for 6 hours. The obtained vulcanized product was polished to obtain a flexographic printing plate material.

The obtained flexographic printing plate material was a laminate in which the printing layer to be engraved, the base fabric layer, the compressive layer, the adhesive layer, and the reinforcement layer were laminated in this order. The plate material had a thickness of 2.84 mm, and the printing layer to be engraved had a thickness of 1.5 mm and a JIS-A hardness of 62. The compressive layer had a thickness of 0.5 mm, and a porosity of 35%.

The flexographic printing plate material was installed to a nylon sleeve using a double-sided tape having a thickness of 0.2 mm. Subsequently, the printing layer was engraved using a CO₂ laser-engraving machine.

According to the plate material for flexography from Example 1, it could be easily installed to the nylon sleeve, because of the excellent size stability of the whole plate material. When the printing was performed at a printing speed of 200 m/minute, the effect of the base fabric layer as the elongation-suppressing layer was exerted, and a movement of the plate material in a printing direction was inhibited, thus resulting in an excellent registering property upon multicolor printing. Further, the bound phenomenon was not observed, and the printing could be performed without delay.

### Comparative Example 1

A flexographic printing plate material was produced in the same manner as in Example 1, except that the base fabric layer was not used. The obtained plate material was a laminate in which the printing layer to be engraved, the compressive layer, the adhesive layer, and the reinforcement layer were laminated in this order and the plate material had a thickness of 2.84 mm. The printing layer to be engraved had a thickness of 1.5 mm, and the compressive layer had a thickness of 0.5 mm.

The flexographic printing plate material was installed to a nylon sleeve using a double-sided tape having a thickness of 0.2 mm. Subsequently, the printing layer was engraved using a CO₂ laser-engraving machine.

The flexographic printing plate material from Comparative Example 1 was inferior in a fitting workability upon the installation to that of Example 1. In addition, when the printing was performed at a printing speed of 200 m/minute, the plate material greatly moved in a printing direction, and the registering property was poor upon the multicolor printing. Furthermore, the plate material had a bad restoring property, a partially patchy phenomenon occurred, and a good printed paper surface could not obtained; thus the printing was suspended.

### Examples 2 to 8

A flexographic printing plate material was produced, and a printing layer for engraving was subjected to laser-engraving in the same manner as in Example 1, except that the plate material thickness was adjusted to 1.5 mm, and the ratio (%) of the thickness of the printing layer to be engraved to the plate material thickness and the ratio (%) of the thickness of the compressive layer to the plate material thickness were changed as shown in Table 1 below.

### Comparative Example 2

A flexographic printing plate material was produced, and a printing layer for engraving was subjected to laser-engraving in the same manner as in Comparative Example 1, except that the plate material thickness was adjusted to 1.5 mm, and the ratio (%) of the thickness of the printing layer to be engraved to the plate material thickness and the ratio (%) of the thickness of the compressive layer to the plate material thickness were changed as shown in Table 1 below.

As for the flexographic printing plate materials obtained in Examples 2 to 8 and Comparative Example 2, a case where a prescribed relief depth (in this case, 0.31 mm) could be obtained by the laser-engraving was evaluated as “good” and a case where the prescribed relief depth could not be obtained, but the plate material could be used depending on the use conditions of users was evaluated as “usable,” and the results are shown in Table 2 below.

In addition, the flexographic printing plate materials from Examples 2 to 8 and Comparative Example 2 were used for printing at a printing speed of 200 m/minute. In all of the plate materials for flexography from Examples 2 to 8 and Comparative Example 2, the ink adhered uniformly to the surface of the printing layer for engraving, there was no ink-sticking, and the fatigue was not observed after the printing. On the other hand, the bound phenomenon did not occur in Examples 2 to 7, and though the bound phenomenon occurred in Example B, it was smaller than that in Comparative Example 2. In Comparative Example 2, the bound phenomenon was larger than that in Example 8, patchy patterns were generated on parts just behind the bounded parts, and printing obstacles occurred.

TABLE 1

| | Thickness of | Printing Layer to | |
|---|---|---|---|
| | Plate Material | be Engraved | Compressive Layer |
| | (mm) | (%) | (%) |
| Example 2 | 1.5 | 65 | 10 |
| Example 3 | 1.5 | 65 | 1 |
| Example 4 | 1.5 | 22 | 10 |
| Example 5 | 1.5 | 22 | 1 |
| Example 6 | 1.5 | 20 | 10 |
| Example 7 | 1.5 | 60 | 15 |
| Example 8 | 1.5 | 70 | 5 |
| Comparative | 1.5 | 70 | 0 |
| Example 2 | | | |

TABLE 2

| | | | | | | | | Comparative |
|---|---|---|---|---|---|---|---|---|
| | Example 2 | Example 3 | Example 4 | Example 5 | Example 6 | Example 7 | Example 8 | Example 2 |
| Bound | No | No | No | No | No | No | Caused | Large |
| Phenomenon | | | | | | | | |
| Relief Depth | Good | Good | Good | Good | Usable | Good | Good | Good |
| Ink-Sticking | No | No | No | No | No | No | No | No |
| Fatigue | No | No | No | No | No | No | No | No |

As apparent from Table 1 and Table 2, in the flexographic printing plate material from Examples 2 to 8, there was relief depth and no ink-sticking, there was no fatigue after the printing, and the bound phenomenon did not occur, or even if it occurred, it was smaller than that in Comparative Example 2. On the other hand, in the flexographic printing plate material from Comparative Example 2, the large bound phenomenon occurred, the patchy patterns were generated on the parts just behind the bounded parts, and the printing obstacles occurred.

### Examples 9 to 14

A flexographic printing plate material was produced, and a printing layer for engraving was subjected to laser-engraving in the same manner as in Example 1, except that the composition of the printing layer to be engraved was changed as shown in Table 3 below. When the flexographic printing plate materials from Examples 9 to 14 were used for printing at a printing speed of 200 m/minute, the printing could be completed without delay.

As for Examples 1 and 9 to 14, a four-stage A to D evaluation of an engraving performance of the printing layer to be engraved on the laser-engraving was performed. A is a state in which melted edges did not appear on the surface of the printing layer to be engraved; B is a state in which melted edges appeared on the printing layer to be engraved, but they were easily removed; C is a state in which melted edges appeared on the surface of the printing layer to be engraved, and some of them remained thereon after a usual cleanup operation and a further cleanup operation was necessary; and D is a state in which many melted edges appeared on the printing layer to be engraved, and many of them remained thereon after a usual cleanup operation and much labor and time are necessary for a further cleanup operation. Also, a four-stage A to evaluation of a kneading performance of the starting materials of the printing layer to be engraved was performed. A is a state in which the starting materials could be uniformly mixed; B is a state in which the dispersibility of the mixture was a little poor, but it could be used without hindrance; C is a state in which the dispersibility of the mixture was poor, and a longer kneading time than that in B was necessary, because a part of the inorganic porous substance remained as it was; D is a state in which even if a specific kneading method was used instead of a usual kneading method, a kneading time longer than that in C was necessary, because the dispersibility of the mixture was poor and a large part of the inorganic porous, substance remained as it was. The evaluation results are shown in Table 3.

TABLE 3

| | Example 9 | Example 10 | Example 1 | Example 11 | Example 12 | Example 13 | Example 14 |
|---|---|---|---|---|---|---|---|
| EPDM | 100 | 100 | 100 | 100 | 100 | 100 | 100 |
| Zinc oxide | 5 | 5 | 5 | 5 | 5 | 5 | 5 |
| Sulfur | 1.5 | 1.5 | 1.5 | 1.5 | 1.5 | 1.5 | 1.5 |
| Vulcanization | 1.5 | 1.5 | 1.5 | 1.5 | 1.5 | 1.5 | 1.5 |
| accelerator | | | | | | | |
| Stearic acid | 1 | 1 | 1 | 1 | 1 | 1 | 1 |
| Inorganic porous | 5 | 8 | 10 | 40 | 55 | 90 | 3 |
| substance | | | | | | | |
| Softener | 5 | 5 | 7 | 15 | 20 | 40 | 5 |
| Total | 119.0 | 122.0 | 126.0 | 164.0 | 184.0 | 239.0 | 117.0 |
| Specific surface area | 63.5 | 101.6 | 127 | 508 | 698.5 | 1016 | 38.1 |
| per 1 g of rubber(m²) | | | | | | | |
| Engraving | B | B | A | A | A | A | D |
| performance | | | | | | | |
| Kneading | A | A | A | A | B | D | A |
| performance | | | | | | | |

As apparent from Table 3, the flexographic printing plate materials from Examples 1 and 9 to 12 had an engraving performance of A or B, and had a kneading performance of A or B. On the other hand, in the flexographic printing plate materials from Examples 13 and 14, the engraving performance or the kneading performance was D. It is desirable, accordingly, to use the inorganic porous substance having a specific surface area of greater than or equal to 40 m² and less than or equal to 1000 m² per 1 g of the rubber, for obtaining the printing layer to be engraved having the good engraving performance and a good kneading performance.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A flexographic printing plate material comprising:
a printing layer for engraving containing rubber;
a compressive layer;
a base fabric layer provided between the printing layer for engraving and the compressive layer; and
a reinforcement layer.

2. The flexographic printing plate material according to claim 1, wherein the printing layer for engraving further comprises an inorganic porous substance having a specific surface area of greater than or equal to 40 m² and less than or equal to 1000 m² per 1 g of the rubber.

3. The flexographic printing plate material according to claim 1, wherein the compressive layer has a porosity of greater than or equal to 10% and less than or equal to 70%.

4. The flexographic printing plate material according to claim 1, wherein the printing layer for engraving has a hardness of greater than or equal to 40 and less than or equal to 85, in accordance with JIS-A.

5. The flexographic printing plate material according to claim 1, wherein
the plate material has a thickness of greater than or equal to 1.5 mm and less than or equal to 2.75 mm, a ratio of a thickness of the compressive layer to the thickness of the plate material is 10% or less, and a ratio of a thickness of the printing layer for engraving to the thickness of the plate material is greater than or equal to 22% and less than or equal to 65%.
